(19) United States
(12) Patent Application Publication
(10) Pub. No.: US 2008/0265833 A1
(43) Pub. Date: Oct. 30, 2008

(54) Driving level control structure eliminating electric noise from motor

(75) Inventors: Shou Te Yu, Tao Yuan City (TW); Ching-Sheng Li, Hsin Chu (TW)

Correspondence Address: BIRCH STEWART KOLASCH & BIRCH, PO BOX 747, FALLS CHURCH, VA, 22040-0747, US

(73) Assignees: Shou Te Yu; ANPEC ELECTRONICS CORPORATION

(21) Appl. No.: 11/797,059

(22) Filed: Apr. 30, 2007

(51) Int. Cl. H02P 23/04

(52) U.S. Cl. 318/807

(57) ABSTRACT

A driving level control structure eliminating electric noise from motor includes a drive control unit, a sensing unit, a setting unit, a first comparing unit, and a frequency control unit. The first comparing unit generates a first discriminating signal based on a reference level signal provided by the sensing unit and a preset level signal provided by the setting unit. The frequency control unit generates a second discriminating signal based on the first discriminating signal. The second discriminating signal is set to a specific frequency fallen out of a human ear perceptible frequency range before being sent to the drive control unit for controlling a motor coil unit to on or off as a current limiting operation, so that electric noise from a motor during the current limiting operation thereof is eliminated.

### FIELD OF THE INVENTION

The present invention relates to a motor driving level control structure, and more particularly, to a driving level control structure eliminating electric noise from a motor during a current limiting operation thereof.

### BACKGROUND OF THE INVENTION

In conventional techniques, a discriminating signal generated in a signal comparison by a sensing unit and a setting unit is utilized to control a driving level of a motor, and control a supplied current not to exceed a preset value of a setting circuit. In the prior art, it is not able to set the discriminating signal to a desired frequency before the discriminating signal is output to a drive control unit, and the frequency of the discriminating signal is determined through self-induction. When the self-inductive frequency falls in a human ear perceptible frequency range, electric noise occurs.

FIG. 1 is a block diagram showing a conventional structure for controlling the driving level of a motor includes a motor coil unit 11, a drive control unit 10, a sensing unit 12, a setting unit 13, and a comparing unit 14, which may be a comparator or a functionally equivalent circuit.

When the sensing unit 12 senses a reference level at the motor coil unit 11, and the setting unit 13 outputs a preset level, the reference level and the preset level are separately output to the comparing unit 14 for comparison. When it is found from the comparison the reference level is higher than the preset level, the comparing unit 14 outputs a discriminating signal to turn off the drive control unit 10, so that no current is flown through the motor coil unit 11. On the other hand, when the reference level of the motor coil unit 11 sensed by the sensing unit 12 and the preset level output by the setting unit 13 are output to the comparing unit 14 for comparison, and it is found from the comparison the reference level Is lower than the preset level, the comparing unit 14 outputs a discriminating signal to turn on the drive control unit 10. The above described comparison is repeated and cycled to control the drive control unit 10 to turn on or off, so that the supplied current does not exceed the preset level of the setting circuit. However, it is not able to set a frequency for the discriminating signal output by the comparing unit 14 before the discriminating signal is output to the drive control unit 10, and the frequency of the discriminating signal is determined through self-induction. When the self-inductive frequency falls in a human ear perceptible frequency range, electric noise occurs.

FIG. 2 is a circuit diagram of the conventional structure for controlling the driving level of a motor shown in FIG. 1. As can be seen from FIG. 2, the conventional structure for controlling the driving level of a motor includes a Hall element 101, a driving element 104, a first resistance 102, a second resistance 103, a third resistance 105, a fourth resistance 106, a first transistor 112, a second transistor 113, a first motor winding 110, a second motor winding 111, a comparator 140, a fifth resistance 132, a sixth resistance 131, a seventh resistance 114, a third transistor 109, a first diode 107, and a second diode 108. Wherein, the Hall element 101, the driving element 104, the first resistance 102, the second resistance 103, the third resistance 105, the fourth resistance 106, the third transistor 109, the first diode 107, and the second diode 108 together form the drive control unit 10.

The first motor winding 110, the second motor winding 111, the first transistor 112, and the second transistor 113 together form the motor coil unit 11. When the sensing unit 12 senses the reference level of the motor coil unit 11, and the fifth resistance 132 and the sixth resistance 131 are voltage divided to output the preset level of the setting circuit, the reference level signal and the preset level signal are input to the comparator 140 for comparison. When it is found from the comparison that the reference level is higher than the preset level, the comparator 140 outputs a discriminating signal to the drive control unit 10 via the third transistor 109, the first diode 107, and the second diode 108, so as to control the pins OUT1, OUT2 of the driving element 104 to turn off the drive control unit 10. At this point, current does not flow through the motor coil unit 11. On the other hand, when the reference level of the motor coil unit 11 sensed by the sensing unit 12 and the preset level of the setting circuit output by the fifth resistance 132 and the sixth resistance 131 are input to the comparator 140 for comparison, and it is found from the comparison that the reference level is lower than the preset level, the comparator 140 outputs a discriminating signal to the drive control unit 10 via the third transistor 109, the first diode 107, and the second diode 108, so as to control the pins OUT1, OUT2 of the driving element 104 to turn on the drive control unit 10. In this manner, the comparison is repeated and cycled to control the drive control unit 10 to turn on or off, so that the current flown through the motor coil unit 11 does not exceed the preset level of the setting circuit. However, the above-described conventional control circuit does not include any frequency setting unit.

Therefore, it is necessary to solve the problem of discomfort electric noise from a motor during a current limiting operation thereof due to a discriminating signal that is not set to a desired frequency before being sent to the drive control unit for controlling the current flown through the motor coil unit.

### SUMMARY OF THE INVENTION

A primary object of the present invention is to provide a motor driving level control structure having a frequency control unit that outputs a second discriminating signal based on a first discriminating signal output by a first comparator, and the second discriminating signal may be set to a specific frequency fallen out of a human ear perceptible frequency range to thereby eliminate the electric noise from a motor during a current limiting operation thereof.

To achieve the above and other object, the driving level control structure eliminating electric noise from motor according to the present invention includes a drive control unit electrically connected to a motor coil unit; a sensing unit electrically connected to the motor coil unit for receiving a reference level at the motor coil unit; a setting unit for generating a preset level of a setting circuit; a first comparing unit, which may be a comparator or other functionally equivalent circuit having at least two inputs separately connected to the sensing unit and the setting unit, and at least one output, so as to receive and compare the reference level and the preset level to generate a first discriminating signal; and a frequency control unit connected to the output of the first comparing unit for receiving the first discriminating signal and generating a second discriminating signal that can be set to a specific frequency, and the second discriminating signal having been set to a specific frequency being sent to the drive control unit for controlling the motor coil unit to on or off as a current limiting operation. Wherein, the second discriminating signal is set to a frequency fallen out of a human ear perceptible frequency range, so that the electric noise from the motor during the current limiting operation thereof is eliminated, enabling the motor to operate quietly.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional structure for controlling the driving level of a motor;

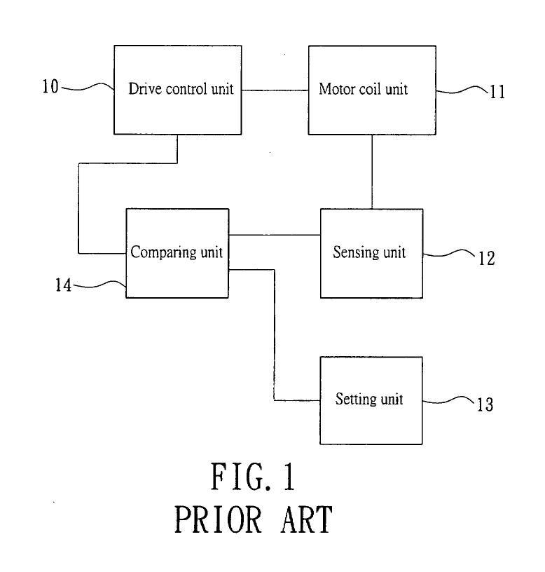

FIG. 2 is a circuit diagram of the conventional control structure for controlling the driving level of a motor shown in FIG. 1;

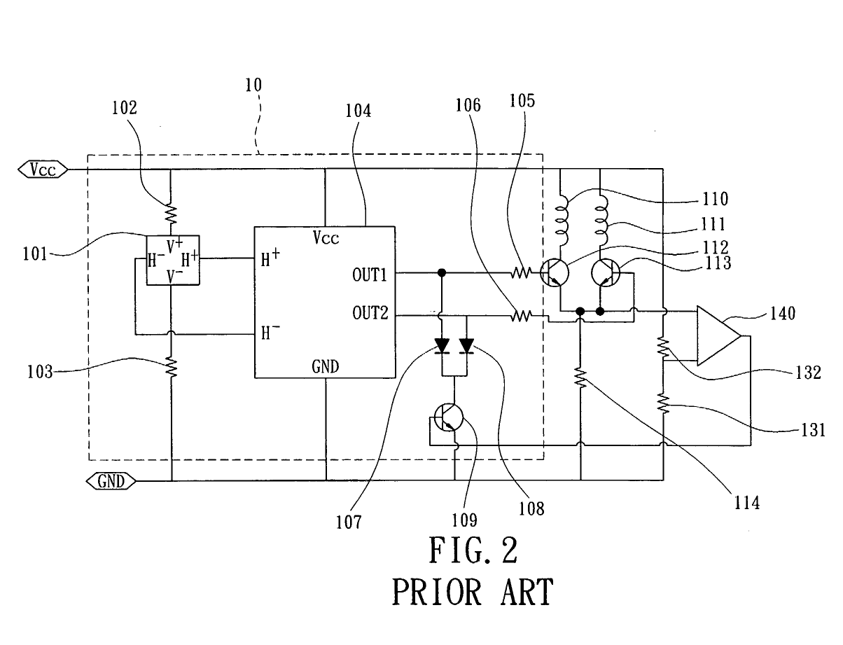

FIG. 3 is a block diagram of a driving level control structure eliminating electric noise from motor according to the present invention; and

FIG. 4 is a circuit diagram of the driving level control structure eliminating electric noise from motor according to an embodiment of the present invention.

### DETAILED DESCRIPTION OF THE PREFERRED EMBODIMENTS

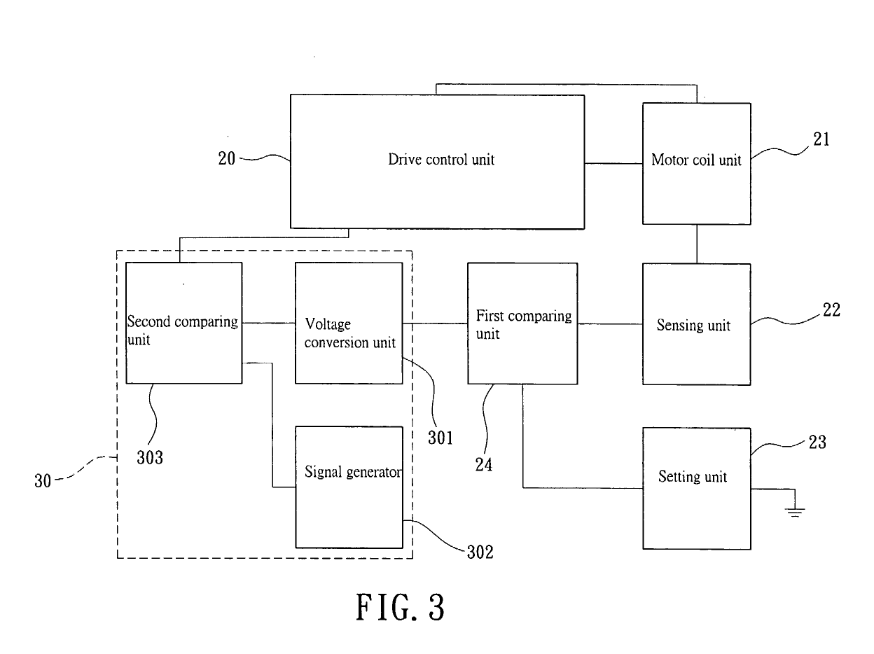

Please refer to FIG. 3 that is a block diagram showing a driving level control structure eliminating electric noise from motor according to the present invention. As shown, the present invention includes a drive control unit 20 electrically connected to a motor coil unit 21 for driving a fan motor (not shown) to rotate; a sensing unit 22 electrically connected to the motor coil unit 21 or the above-mentioned fan motor, so as to receive a reference level at the motor coil unit 21; a setting unit 23 for generating a preset level of a setting circuit; a first comparing unit 24 having two inputs for separately receiving the reference level and the preset level, and capable of comparing the two received level signals to output a first discriminating signal via an output thereof; a frequency control unit 30 including a voltage conversion unit 301, a signal generator 302, and a second comparing unit 303 for outputting a second discriminating signal based on the first discriminating signal. The second discriminating signal can be set to a specific frequency before it is output to the drive control unit 20 for controlling the motor coil unit 21 to turn on or off as a current limiting operation. By setting the second discriminating signal to a specific frequency fallen out of a human ear perceptible frequency range, it is able to eliminate electric noise from the motor during the current limiting operation thereof.

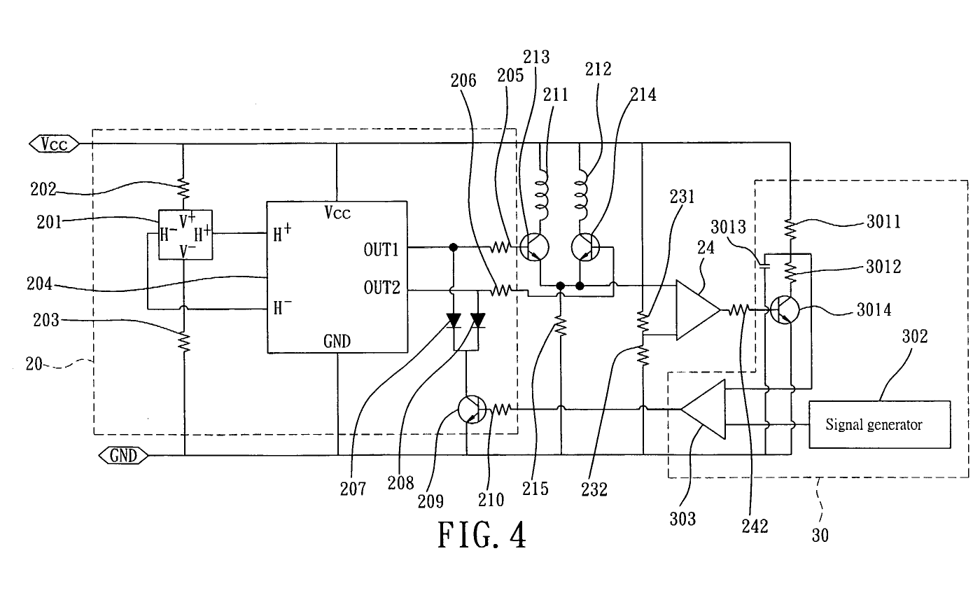

Please also refer to FIG. 4 that shows a circuit diagram for a preferred embodiment of the present invention. As shown, in the circuit of the present invention, there are included a Hall element 201, a first resistance 202, a second resistance 203, a driving element 204, a third resistance 206, a fourth resistance 205, a first diode 207, a second diode 208, a fourth transistor 209, a tenth resistance 210, a first motor winding 211, a second motor winding 212, a first transistor 213, a second transistor 214, a seventh resistance 215, a fifth resistance 231, a sixth resistance 232, a first comparing unit 24, an eleventh resistance 242, a capacitance 3013, an eighth resistance 3011, a ninth resistance 3012, a third transistor 3014, a triangular wave generator 302, and a second comparing unit 303. The above-mentioned drive control unit 20 is embodied by the Hall element 201, the first resistance 202, the second resistance 203, the driving element 204, the third resistance 206, the fourth resistance 205, the first diode 207, the second diode 208, the fourth transistor 209, and the tenth resistance 210.

The above-mentioned motor coil unit 21 is embodied by the first motor winding 211, the second motor winding 212, the first transistor 213, the second transistor 214, the seventh resistance 215.

The above-mentioned frequency control unit 30 is embodied by the capacitance 3013, the eighth resistance 3011, the ninth resistance 3012, the third transistor 3014, the triangular wave generator 302, and the second comparing unit 303.

The first and the second comparing unit 24, 303 are preferably comparators, and are hereinafter referred to as the first and the second comparator, respectively.

The sensing unit 22 is able to sense the current at the first motor winding 211 and the second motor winding 212 of the motor coil unit 21 and produce a reference level. When the fifth and the sixth resistance 231, 232 are changed to different resistance values, divided voltages of different division ratios may be obtained to thereby set or change a preset level. In the present invention, the fifth and the sixth resistance 231, 232 are voltage divided to output a preset level of the setting circuit. The previous two level signals are separately sent to the first comparator 24 for comparison. When it is found from the comparison that the reference level is higher than the preset level, the first comparator 24 outputs a first discriminating signal, which is sent through the eleventh resistance 242 and a collector of the third transistor 3014 to the voltage conversion unit 301 to be converted into a voltage reference value. In the illustrated embodiment of the present invention, the voltage conversion unit 301 is, for example, an RC integrating circuit, and consists of the capacitance 3013, the eighth resistance 3011, and the ninth resistance 3012.

In the illustrated embodiment of the present invention, the signal generator 302 may be, for example, a triangular wave generator. However, it is understood the signal generator 302 is not limited to the triangular wave generator, but may be any other equivalent signal generating circuit capable of generating a signal that can be set to a specific frequency. The triangular wave generator 302 generates a pulse signal that may be set to a desired frequency. The voltage reference value and the pulse signal are separately sent to the second comparator 303 for comparison, so that a second discriminating signal is generated. The second discriminating signal is set to a specific frequency before it is sent through the tenth resistance 210, the fourth transistor 209, the first diode 207, and the second diode 208 to control two pins OUT1 and OUT2 of the driving element 204 of the drive control unit 20 to turn off the drive control unit 20, and accordingly, the motor coil unit 21.

On the other hand, when it is found from the comparison at the first comparator 24 that the reference level is lower than the preset level, a first discriminating signal is output and sent through the eleventh resistance 242 and the collector of the third transistor 3014 to the RC integrating circuit 301, at where the first discriminating signal is converted into a voltage reference value. Meanwhile, the triangular wave generator 302 generates a pulse signal that may be set to a desired frequency. The voltage reference value and the pulse signal are separately sent to the second comparator 303 for comparison, so that a second discriminating signal is generated. The second discriminating signal is set to a specific frequency before being sent through the tenth resistance 210, the fourth transistor 209, the first diode 207, and the second diode 208 to control the two pins OUT1 and OUT2 of the driving element 204 of the drive control unit 20 to turn on the drive control unit 20, and accordingly, the motor coil unit 21.

The above comparison is repeated and cycled to control the drive control unit to on or off as a current limiting operation, so that current is controlled not to exceed the preset level of the setting circuit.

In the present invention, the frequency control unit 30 consists of the capacitance 3013, the eighth resistance 3011, the ninth resistance 3012, the third transistor 3014, the triangular wave generator 302, and the second comparing unit 303 for directly setting the output second discriminating signal to a frequency fallen out of the human ear perceptible frequency range. The second discriminating signal with the particularly set frequency is then output to the control drive unit 20 for controlling the motor coil unit 21. The problem of a discriminating signal having a self-inductive frequency to cause motor noise in the prior art is therefore eliminated.

The human ear perceptible frequency range varies with different persons, and is generally from 20 to 20 k Hz. In the present invention, the second discriminating signal output from the frequency control unit 30 is set to a frequency fallen out of the human ear perceptible frequency range, so that the motor does not produce electric noise during the current limiting operation thereof.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A driving level control structure eliminating electric noise from motor, comprising:
a drive control unit electrically connected to a motor coil unit;
a sensing unit electrically connected to the motor coil unit for receiving a reference level at the motor coil unit;
a setting unit for generating a preset level of a setting circuit;
a first comparing unit having at least two inputs separately connected to the sensing unit and the setting unit, and at least one output; the first comparing unit receiving and comparing the reference level and the preset level to generate a first discriminating signal; and
a frequency control unit connected to the output of the first comparing unit for receiving the first discriminating signal and generating a second discriminating signal; the second discriminating signal being set to a specific frequency before being sent to the drive control unit for controlling the motor coil unit to turn on or off as a current limiting operation;
wherein the second discriminating signal is set to a frequency fallen out of a human ear perceptible frequency range, so that no electric noise from motor would be produced during the current limiting operation.

2. The driving level control structure eliminating electric noise from motor as claimed in claim 1, wherein the frequency control unit includes a voltage conversion unit, a signal generator, and a second comparing unit electrically connected to one another.

3. The driving level control structure eliminating electric noise from motor as claimed in claim 2, wherein the first discriminating signal output by the first comparing unit is sent to the voltage conversion unit of the frequency control unit and converted into a voltage reference value; the signal generator generating a pulse signal that can be set to a specific frequency; the second comparing unit receiving and comparing the voltage reference value and the pulse signal, and outputting a second discriminating signal based on the voltage reference value and the pulse signal; and the second discriminating signal being set to the specific frequency before being sent to the drive control unit for controlling the motor coil unit.

4. The driving level control structure eliminating electric noise from motor as claimed in claim 3, wherein the voltage conversion unit is an RC integrating circuit.

5. The driving level control structure eliminating electric noise from motor as claimed in claim 3, wherein the signal generator is able to set the pulse signal to a specific frequency, and the output pulse signal is selected from the group consisting of triangular wave, toothed wave, and sine wave.

6. The driving level control structure eliminating electric noise from motor as claimed in claim 1, wherein the first and the second comparing unit are comparators.

7. The driving level control structure eliminating electric noise from motor as claimed in claim 3, wherein the pulse signal is set to a frequency fallen out of a human ear perceptible frequency range.

8. The driving level control structure eliminating electric noise from motor as claimed in claim 1, wherein the sensing unit, the setting unit, the first comparing unit, and the frequency control unit are provided in a fan motor.

9. The driving level control structure eliminating electric noise from motor as claimed in claim 1, wherein the sensing unit, the setting unit, the first comparing unit, and the frequency control unit are independent circuits and separable from a fan motor.

10. The driving level control structure eliminating electric noise from motor as claimed in claim 1, wherein the sensing unit, the setting unit, the first comparing unit, and the frequency control unit as well as the drive control unit are integrated into an integrated circuit.

11. The driving level control structure eliminating electric noise from motor as claimed in claim 1, wherein the frequency control unit and the drive control unit are integrated into an integrated circuit.

12. The driving level control structure eliminating electric noise from motor as claimed in claim 1, wherein the voltage conversion unit and the second comparing unit of the frequency control unit as well as the drive control unit are integrated into an integrated circuit.

13. The driving level control structure eliminating electric noise from motor as claimed in claim 1, wherein the voltage conversion unit and the signal generator of the frequency control unit as well as the drive control unit are integrated into an integrated circuit.

14. The driving level control structure eliminating electric noise from motor as claimed in claim 1, wherein the second comparing unit and the signal generator of the frequency control unit as well as the drive control unit are integrated into an integrated circuit.

15. The driving level control structure eliminating electric noise from motor as claimed in claim 1, wherein the voltage conversion unit of the frequency control unit and the drive control unit are integrated into an integrated circuit.

16. The driving level control structure eliminating electric noise from motor as claimed in claim 1, wherein the signal generator of the frequency control unit and the drive control unit are integrated into an integrated circuit.

17. The driving level control structure eliminating electric noise from motor as claimed in claim 1, wherein the second comparing unit of the frequency control unit and the drive control unit are integrated into an integrated circuit.
